(19) United States
(12) Patent Application Publication
(10) Pub. No.: US 2026/0289345 A1
(43) Pub. Date: Sep. 24, 2026

(54) WELL EVENT DETECTION AND PRODUCTION PREDICTION SYSTEM

(71) Applicant: Enverus, Inc, Austin, TX (US)

(72) Inventors: Sam Dawson, Austin, TX (US); Eric Troilo, North Wildwood, NJ (US); Jakub Hladik, Brno (CZ); Claire McKenzie, Austin, TX (US); Jiarao Huang, Calgary (CA); Manuj Nikhanj, Calgary (CA); Livan Alonso, Wayne, PA (US)

(73) Assignee: Enverus, Inc., Austin, TX (US)

(21) Appl. No.: 19/085,321

(22) Filed: Mar. 20, 2025

(51) Int. Cl. G06N 5/04

(52) U.S. Cl. CPC G06N 5/04

(57) ABSTRACT

A computing system identifies production data for a target well. The computing system detects a shut-in event by analyzing the production data for the target well, the shut-in event corresponding to an event during operation of the target well in which operation of the target well is halted or suspended. The computing system receives reporting data for the target well and a plurality of wells co-located with the target well. The computing system classifies the detected shut-in event into one of a plurality of possible categories of shut-in events based on the reporting data. The computing system determines whether a refracture event has occurred for the target well based on the reporting data. The computing system forecasts an impact of the shut-in event on future production of the target well using decline curve analysis on a segment of the production data corresponding to the shut-in event.

### FIELD OF DISCLOSURE

The present disclosure generally relates to a method and a system for well event detection and prediction.

### BACKGROUND

In multi-well pads, hydraulic fractures of a well may enable communication with other near-by wells, which may influence the well's production performance. Such inter-well communication is known in the art as “well interference.” Quantifying well interference may aid in optimizing well spacing, which may lead to higher productivity of a well field.

### SUMMARY

In some embodiments, a method for well event detection and production prediction is disclosed herein. A computing system identifies production data for a target well from one or more third party data systems. The production data includes oil or gas production for the target well. The computing system detects a shut-in event by analyzing the production data for the target well, the shut-in event corresponding to an event during operation of the target well in which operation of the target well is halted or suspended. The computing system receives reporting data for the target well and a plurality of wells co-located with the target well. The computing system classifies the detected shut-in event into one of a plurality of possible categories of shut-in events based on the reporting data. The plurality of possible categories of shut-in events includes a pad shut-in event, an offset shut-in event, or a generic shut-in event. The computing system determines whether a refracture event has occurred for the target well based on the reporting data. The computing system forecasts an impact of the shut-in event on future production of the target well using decline curve analysis on a segment of the production data corresponding to the shut-in event. The computing system causes display of one or more graphical elements quantifying the impact of the shut-in event for the target well.

In some embodiments, a non-transitory computer readable medium is disclosed herein. The non-transitory computer readable medium includes one or more sequences of instructions, which, when executed by a processor, causes a computing system to perform operations. The operations include identifying, by the computing system, production data for a target well from one or more third party data systems. The production data includes oil or gas production for the target well. The operations further include detecting, by the computing system, a shut-in event by analyzing the production data for the target well. The shut-in event corresponds to an event during operation of the target well in which operation of the target well is halted or suspended. The operations further include receiving, by the computing system, reporting data for the target well and a plurality of wells co-located with the target well. The operations further include classifying, by the computing system, the detected shut-in event into one of a plurality of possible categories of shut-in events based on the reporting data. The plurality of possible categories of shut-in events includes a pad shut-in event, an offset shut-in event, or a generic shut-in event. The operations further include determining, by the computing system, whether a refracture event has occurred for the target well based on the reporting data. The operations further include forecasting, by the computing system, an impact of the shut-in event on future production of the target well using decline curve analysis on a segment of the production data corresponding to the shut-in event. The operations further include causing, by the computing system, display of one or more graphical elements quantifying the impact of the shut-in event for the target well.

In some embodiments, a system is disclosed herein. The system includes a processor and a memory. The memory has programming instructions stored thereon, which, when executed by the processor, causes the system to perform operations. The operations include identifying production data for a target well from one or more third party data systems. The production data includes oil or gas production for the target well. The operations further include detecting a shut-in event by analyzing the production data for the target well. The shut-in event corresponds to an event during operation of the target well in which operation of the target well is halted or suspended. The operations further include receiving reporting data for the target well and a plurality of wells co-located with the target well. The operations further include classifying the detected shut-in event into one of a plurality of possible categories of shut-in events based on the reporting data. The plurality of possible categories of shut-in events includes a pad shut-in event, an offset shut-in event, or a generic shut-in event. The operations further include determining whether a refracture event has occurred for the target well based on the reporting data. The operations further include forecasting an impact of the shut-in event on future production of the target well using decline curve analysis on a segment of the production data corresponding to the shut-in event. The operations further include causing display of one or more graphical elements quantifying the impact of the shut-in event for the target well.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a block diagram illustrating an exemplary workflow for detecting shut-in events and forecasting the impact of those shut-in events, according to exemplary embodiments.

FIG. 3A illustrates an exemplary graphical user interface (GUI) associated with event detection system and application, according to example embodiments.

FIG. 3B illustrates an exemplary graphical user interface (GUI) associated with event detection system and application, according to example embodiments.

FIG. 3C illustrates an exemplary graphical user interface (GUI) associated with event detection system and application, according to example embodiments.

FIG. 3D illustrates an exemplary graphical user interface (GUI) associated with event detection system and application, according to example embodiments.

FIG. 4 illustrates an exemplary graphical user interface (GUI) associated with event detection system and application, according to example embodiments.

FIG. 5 is a flow diagram illustrating a method for well event detection and prediction, according to example embodiments.

FIG. 6A is a block diagram illustrating a computing device, according to example embodiments of the present disclosure.

FIG. 6B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One of the key problems in understanding a well's production is that the producing lifecycle is frequently impacted by other operations. A well may be shut in due to offset development, intentional reworking, infill development, or any other operational scenario. These shut-ins cause a range of impacts, from positive EUR bumps to decreased production.

To understand the impact of these shut-ins, one or more techniques disclosed herein utilize a novel model that creates distinct segments of production between these events. Segmenting production data enables accurate identification and quantification of the impact these events have on company production and therefore cashflow.

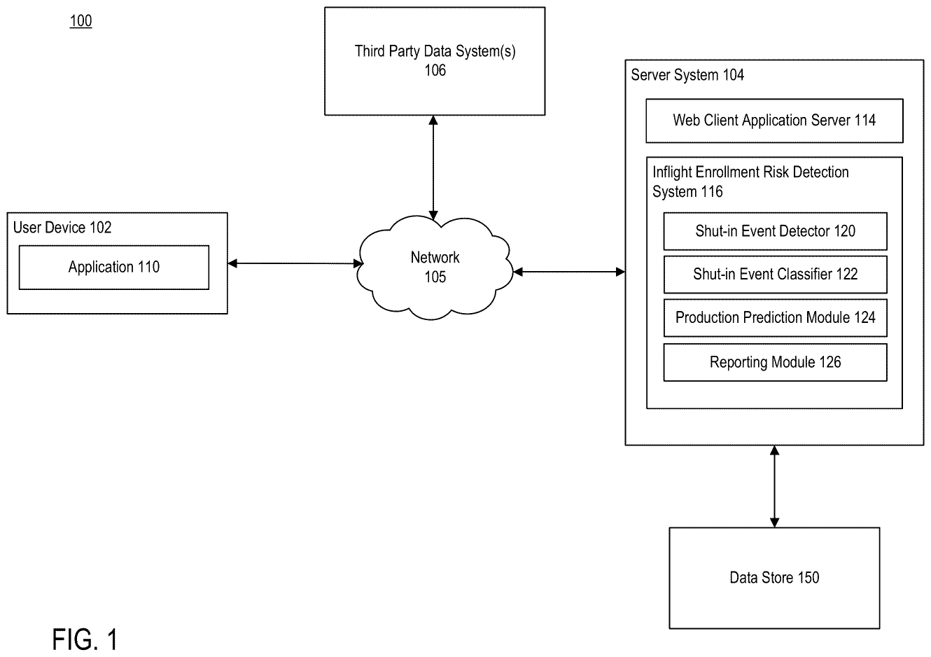

FIG. 1 is a block diagram illustrating a computing environment 100, according to example embodiments. Computing environment 100 may include user device 102, server system 104, and third party data systems 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user, such as, for example, a user associated with an organization, such as an organization associated with server system 104. User device 102 may be representative of a mobile device, a tablet, a desktop computer, or any computing system having the capabilities described herein. User device 102 may include an application 110 executing thereon. Application 110 may be representative of an application associated with server system 104. For example, application 110 may be representative of an application that detects interference events associated with a given well, such as event detection system 116 associated with server system 104. In some embodiments, application 110 may be a standalone application associated with server system 104, such as a mobile application, tablet application, desktop application, or, more generally, a software application affiliated with an entity associated with server system 104. In some embodiments, application 110 may be representative of a web browser configured to communicate with server system 104, such that an end user may gain access to event detection system 116 of server system 104 via a web browser. More generally, application 110 may be configured to provide an interface between user device 102 and server system 104 for the purpose of allowing a user to access event detection system 116.

Server system 104 may be representative of one or more servers configured to communicate with one or more user devices, such as user device 102. In some embodiments, server system 104 may be configured to host one or more virtualization elements (e.g., virtual machines or containers), such that components of server system 104 may be upscaled or downscaled, depending on demand or user request.

Server system 104 may include web client application server 114 and event detection system 116. Event detection system 116 may be representative of a system configured to detect, classify, and assess the impact of well shut-in events. As shown, event detection system 116 may include one or more modules. For example, event detection system 116 may include shut-in event detector 120, shut-in event classifier 122, production prediction module 124, and reporting module 126. Each of shut-in event detector 120, shut-in event classifier 122, production prediction module 124, and reporting module 126 may be comprised of one or more software modules. The one or more software modules are collections of code or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that are interpreted to obtain the actual computer code. The one or more software modules may also include one or more hardware components.

One or more aspects of an example algorithm may be performed by the hardware components (e.g., circuitry) itself, rather than as a result of the instructions.

Shut-in event detector 120 may be configured to detect shut-in events for a target well. A shut-in event may broadly refer to an event during operation of a target well in which the operation is halted or suspended by closing the valves at the wellhead. In some embodiments, shut-in event detector 120 may detect a shut-in event based on reported production data for the target well. For example, shut-in event detector 120 may be configured to interface with one or more third party data systems 106 that provide real-time, near-real time, or periodic reports regarding the production of the target well. For each batch of reported data, shut-in event detector 120 may analyze the production data to determine whether a shut-in event has occurred. In some embodiments, an operator may pre-define what constitutes a shut-in event for purposes of detection. For example, an operator, in the early life of a well (e.g., the period between the initial production peak and two-months post peak) may define a shut-in event as occurring when shut-in event detector 120 detects a month-over-month decline of X % for consecutive months (e.g., 85% decrease over two consecutive months). In some embodiments, an operator may more narrowly define when a shut-in event is detected by requiring a minimum peak value (e.g., minimum peak of 40 bbl or mcf). In some embodiments, an operator may more narrowly define when a shut-in event is detected by requiring a month of zero production. For the remainder of the well's life (i.e., after the early life of the well), the operator may define a shut-in event differently. For example, for the latter part of the well's life, an operator may more broadly define when a shut-in event is detected when shut-in event detector 120 detects month-over-month decline of Y %, where Y %<=X %. In another example, for the latter part of the well's life, an operator may more broadly define when a shut-in event is detected when shut-in event detector 120 detects a month of zero production.

Shut-in event classifier 122 may be configured to classify the shut-in events detected by shut-in event detector 120. In some embodiments, shut-in event detector classifier 122 may be configured to classify the shut-in events into one of a plurality of possible categories of shut-in events. Exemplary categories of shut-in events may include, but are not limited to pad infill events, offset infill events, and shut-in events.

Pad infill event may broadly refer to an event (e.g., spud or rig release date) that occurs on the same well pad as the target well.

Offset infill events may broadly refer to an event (e.g., spud or rig releasee date) that occurs on a well pad adjacent to the target well pad of the target well. Whether a well pad is adjacent to a target pad may depend on whether a determined distance between the well pad and the target well pad is below a threshold amount. In some embodiments, the distance may be determined based on an average distance of wells in the target pad to wells in the other pad.

Shut-in events may broadly refer to all other events that do quality as either a pad infill event, offset infill event, or refraction event.

In some embodiments, shut-in event classifier 122 may be configured to classify the detected shut-in event based on reported information retrieved from third party data systems 106. For example, shut-in event classifier 122 may classify a shut-in event as a pad infill event based on the pad identifiers associated with the wells in the reported information. Shut-in event classifier 122 may similarly classify a shut-in event as an offset infill event based on wells associated with pad identifiers of pads determined to be adjacent to the target pad of the target well.

As those skilled in the art understand, the detection of shut-in events and the classification of shut-in events may not occur at the same time. For example, information that may be necessary to classify the shut-in event may not be available for months after the shut-in event was detected. As such, shut-in event classifier 122 may temporarily classify a shut-in event as a generic “shut-in event,” while shut-in event classifier 122 waits for information that can be used to classify the shut-in event.

In some embodiments, shut-in event classifier 122 may further be configured to determine whether the target well was refractured while the shut-in event occurred. Refracturing may broadly refer to the process of performing a second or subsequent fracking operation on a well that has already been completed and previously fractured. Shut-in event classifier 122 may determine that a refracturing has occurred based on a received completion record of the event from third party data systems 106. In some embodiments, the completion record must indicate non-zero proppant material present. In some embodiments, the refracturing may be shut-in based. For example, a refracture may be shut-in based if the refracture event occurred within a month buffer of any shut-in event. In some embodiments, the refracturing may be date based. For example, a refracture may be date based if it occurred two years after initial completion date and one year after the first product date. In some embodiments, the refracture date may be date based if it occurred two years before the next reported completion event tagged to the well. If the shut-in event and date overlap, shut-in classifier may prioritize the information from the event identified refracture.

Production prediction module 124 may be configured to forecast production data for a target well at various points of a well's lifetime. In some embodiments, production prediction module 124 may be configured to generate forecasted production data for a target well each time a shut-in event occurs. In this manner, production prediction module 124 may provide end users with an analysis for how a certain event (e.g., pad infill event, offset infill event, shut-in event, refracture event) affected the forecasted production of that well.

In some embodiments, production prediction module 124 may employ a decline curve analysis to forecast production data for a target well. In some embodiments, production prediction module 124 may generate one or more decline curves using Arps equation. To generate a decline curve, in some embodiments, production prediction module 124 may check whether there is at least four months of production (e.g., peak and three months decline). In some embodiments, the detected shut-in event duration may be required to be at least two months old. Production prediction module 124 may then fit an Arps curve through this segment of data to project or forecast production data for the target well.

Reporting module 126 may be configured to generate one or more production metrics for each shut-in event. For example, to quantify the impact of a shut-in event, reporting module 126 may be configured to pre-generate a collection of production comparison metrics for the identified shut-in events. Reporting module 126 may compare the outputs from the target shut-in event to the pre-shut-in event data in order to see the impact of the event as the well moves through its producing life.

Exemplary metrics may include, but are not limited to:

| | | Sample Calculation |
|---|---|---|
| Name | Definition | for Event 2 |
| Initial Rate | Initial rate used for the decline curve | |
| | calculated | |
| B Factor | Decline curve b factor | |
| Decline Rate | Decline curve monthly decline rate | |
| EUR First 360, After | The precalculated 360 month EUR for | =(Production Data from |
| Event (bbl) | the summary type curve, based on and | month 0 to month B) + (Event |
| | including all real data available after | 2 curve data from month B + 1 |
| | the given production event. | to month 360) |
| EUR First 360, Before | The precalculated 360 month EUR for | =(Production Data from |
| Event (bbl) | the summary type curve, based on and | month 0 to month B) + (Event |
| | including all real data available before | 1 curve data from month B + 1 |
| | the given production event. | to month 360) |
| EUR First 360, Event | The difference between the First 360 | =(EUR First 360, After |
| Impact (bbl) | EUR Before Event and the First 360 | Event) − (EUR First 360, |
| | EUR After Event. | Before Event) |
| EUR First 360, Total | The precalculated 360 month EUR for | =(Production Data from |
| (bbl) | the summary type curve, including all | month 0 to month D) + |
| | real data for the entirety of the well's | (Event 3 curve data from |
| | production history and based on the | month D + 1 to month 360) |
| | final identified segment of production. | |
| Cumulative Production | Cumulative historic production before | =(Production Data from |
| Before Event (bbl) | the identified production event. | month 0 to month B) |
| Event Production | The difference between the historic | =(Event 1 curve data from |
| Difference (bbl) | production before the identified | month B + 1 to month C) − |
| | production event and the subsequent | (Production Data from month |
| | predicted production until the end of | B + 1 to month C) |
| | the following segment and the | |
| | cumulative historic production until the | |
| | end of the following segment. | |
| Post Event Peak (bbl) | The highest monthly rate identified | |
| | after the production event. | |
| Production Difference | The Event Production Difference | |
| % | divided by the real data from the start | |
| | of the production event to the end of | |
| | the segment, expressed as a percentage. | |
| Peak to Peak Ratio | The ratio between the peak rate before | |
| | and after the production event. | |
| Discounted Production | Discounted production volume at a | |
| Volume, Before Event | 10% rate to approximate net present | |
| (bbl) | volumes, based on the production data | |
| | before the production event. | |
| Discounted Production | Discounted production volume at a | |
| Volume, After Event | 10% rate to approximate net present | |
| (bbl) | volumes, based on the production data | |
| | after the production event. | |
| Discounted Production | Difference between the Discounted | |
| Volume, Event Impact | Production Before Event and After | |
| (bbl) | Event. | |

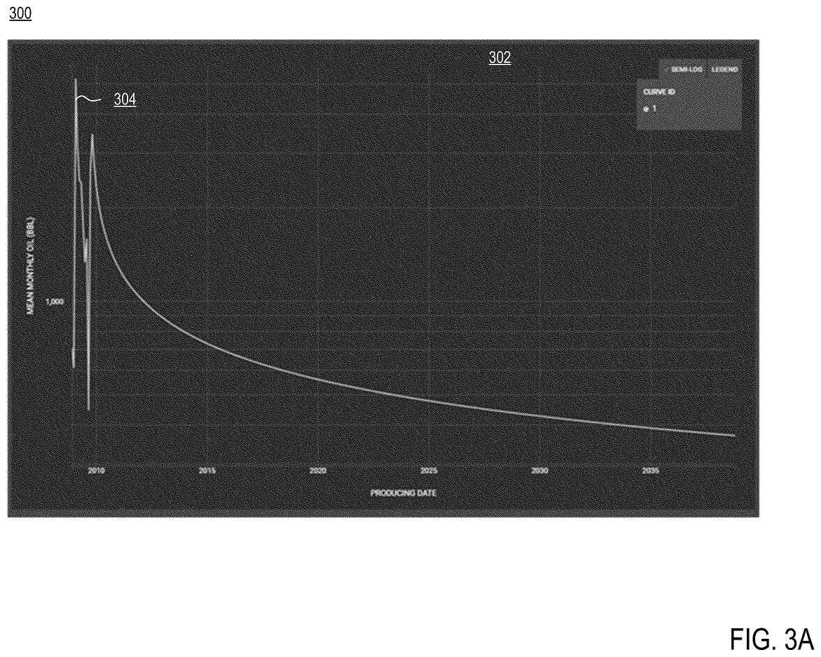

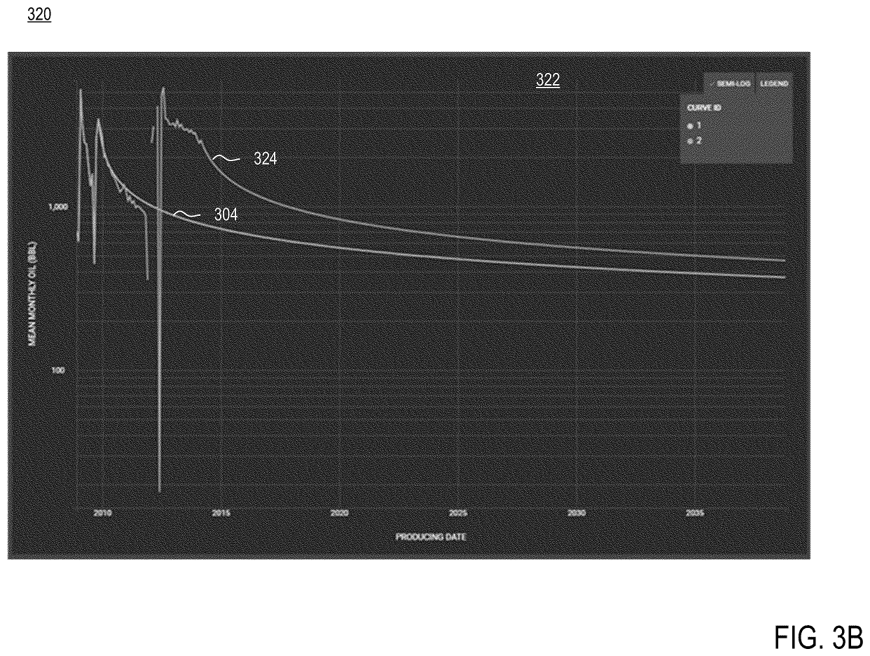

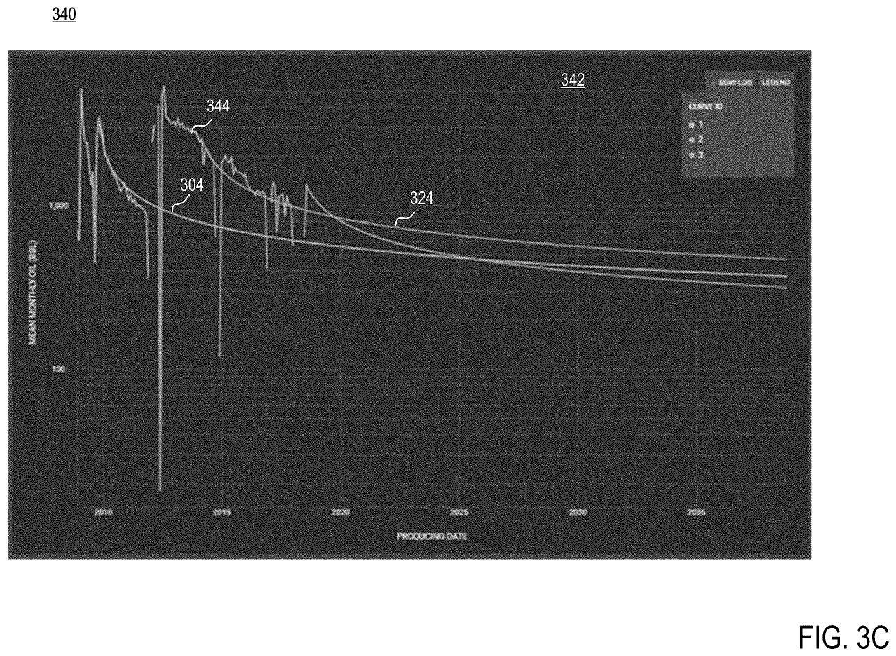

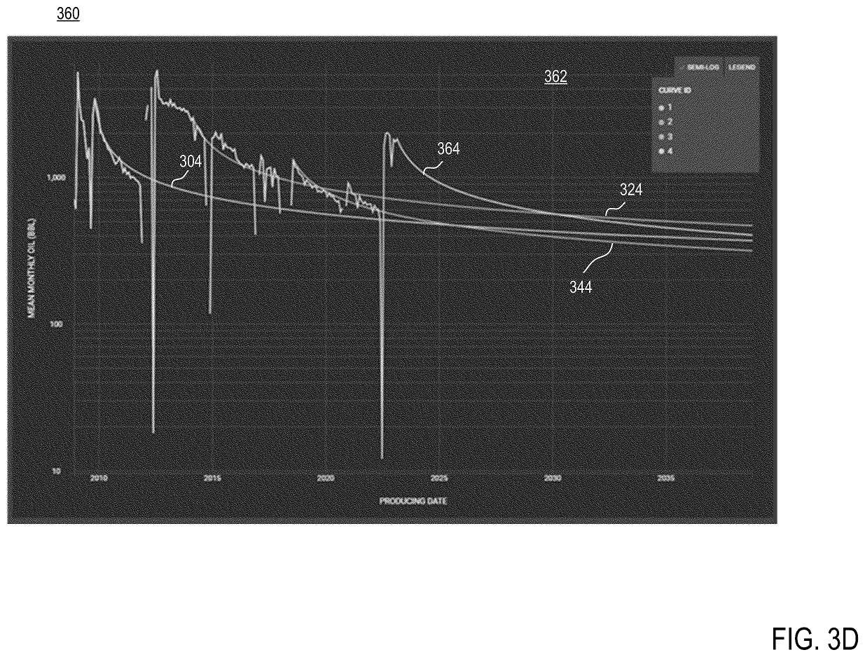

In some embodiments, reporting module 126 may be configured to generate one or more graphical outputs quantifying the impact of the detected shut-in events. Exemplary graphical outputs are shown and discussed below in conjunction with FIGS. 3A-3D.

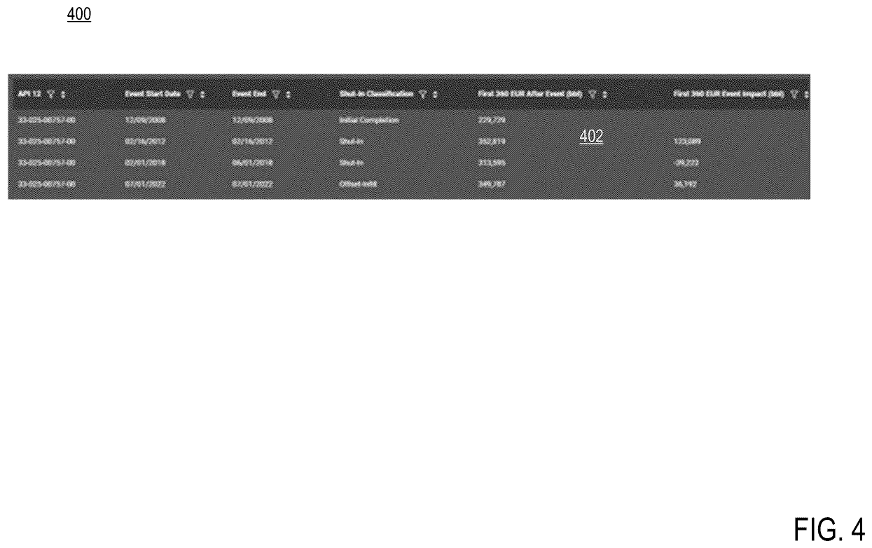

In some embodiments, reporting module 126 may be configured to maintain a chart of metrics for each well. The chart may include various metrics associated with detected shut-in event. An exemplary chart is shown and discussed below in conjunction with FIG. 4.

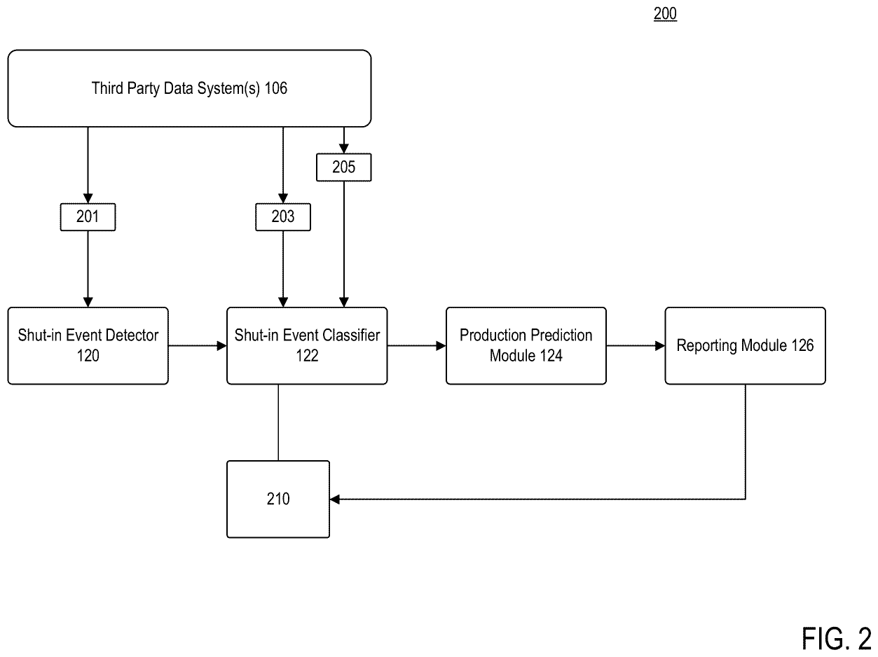

FIG. 2 is a block diagram illustrating an exemplary workflow 200 for detecting shut-in events and forecasting the impact of those shut-in events, according to exemplary embodiments. As shown, shut-in event detector 120 may receive or retrieve production data 201 from one or more third party data systems 106. Production data 201 may represent production data that has been reported for a target well. In some embodiments, production data may include production data for both oil production and gas production for a target well. As discussed above, event detection system 116 may be configured to receive in real-time, near real-time, or periodically production data 201 for a target well. Based on production data 201, shut-in event detector 120 may analyze production data 201 to determine whether a shut-in event has been detected. If a shut-in event has been detected, then workflow 200 may proceed to shut-in event classifier 122.

Shut-in event classifier 122 may be configured to classify the shut-in event. In some embodiments, shut-in event classifier may not yet have the necessary information for classifying the shut-in event. For example, reporting records for the same well, same pad, or adjacent wells may not yet be reported or available from third party data system(s) 106. For example, as shown, reporting data 203 and reporting data 205 may be reported or retrieved by shut-in event classifier 122 periodically, as they are made available or posted by third party data systems 106. For example, in operation, shut-in event classifier 122 may receive or retrieve reporting data 203 from third party data systems 106. In some embodiments, shut-in event classifier 122 may determine whether the shut-in event is a pad infill event. For example, shut-in event classifier 122 may analyze reporting data 203 to determine if there have been any well infill events on the same pad as the target pad. In some embodiments, shut-in event classifier 122 may determine whether the shut-in event is an offset infill event. For example, shut-in event classifier 122 may analyze reporting data 203 to determine if there have been any infill events on pads adjacent to the target pad. In some embodiments, shut-in event classifier 122 may initially classify the shut-in event as a generic shut-in event, with the expectation that later received production data will help provide clarification for the type of shut-in event. In some embodiments, shut-in event classifier 122 may also determine whether the target well has been refractured. For example, shut-in event classifier 122 may analyze reporting data 203 to determine if a refracture event has been reported for the target well. Workflow 200 may then proceed to production prediction module 124.

Production prediction module 124 may forecast production data for the target well based on production data 201. In some embodiments, production module 124 may forecast production data for the target well for the segment of the production data corresponding to the detected shut-in event. In some embodiments, production prediction module 124 may forecast production data for the segment of production data for the target well by applying a decline curve analysis to the production data. In this manner, production prediction module 124 may project the effect of the shut-in event on the production of the target well. Workflow 200 may then proceed to reporting module 126.

In some embodiments, reporting module 126 may be configured to generate or maintain a chart 210 of metrics for the target well. For example, chart 210 may include various metrics associated with detected shut-in events, such as, but not limited to the date of the shut-in event, the duration of the shut-in event, estimated ultimate recovery projection of the shut-in event, or the like. Such chart 210 may be stored in data store 150 for subsequent updating. In some embodiments, reporting module 126 may generate one or more graphical outputs quantifying the impact of the detected shut-in events.

As discussed, because event detection system 116 may not have a complete picture of the detected shut-in event as of the time production data 201 or reporting data 203 is received, workflow 200 may be an iterative process, in which shut-in event classifier 122 continuously or periodically analyzes subsequent reporting data 205 to determine whether the shut-in event can be classified or whether a refracture event can be flagged. In such embodiments, the data may flow to reporting module 126, such that reporting module 126 can update chart 210.

FIG. 3A illustrates an exemplary graphical user interface (GUI) 300 associated with event detection system 116 and application 110, according to example embodiments. In some embodiments, GUI 300 may be generated by reporting module 126 based on information generated by production prediction module 124. GUI 300 may be sent to user device 102 for display via application 110.

As shown, GUI 300 may include a chart 302 that illustrates a decline curve 304 fit to received production data. Chart 302 illustrates that production began on or around December 2008 and continued uninterrupted until about February 2012. At that point, the operator decided to conduct a refracture, which is reflected in the clear change in the production profile.

FIG. 3B illustrates an exemplary GUI 320 associated with event detection system 116 and application 110, according to example embodiments. In some embodiments, GUI 320 may be generated by reporting module 126 based on information generated by production prediction module 124. GUI 320 may be sent to user device 102 for display via application 110.

As shown, GUI 320 may include a chart 322 that illustrates decline curve 304 fit to previously received production data and decline curve 324 fit to newly received production data. As previously discussed, event detection system 116 utilizes event detection to recognize downtime in a well's profile and classify what was occurring around the downtime. In this example, shut-in event classifier 122 determined that no other infill activity occurred within a half-mile radius of the target well. Shut-in event classifier 122 may have also determined that a refracture event was reported for the target well. As such, shut-in event classifier 122 may indicate that a refracture event occurred for the target well. Furthermore, as shown, the newly detected shut-in event, corresponding to decline curve 324, improved the forecasted production profile of the target well, which can be visualized by comparing decline curve 324 to decline curve 304.

FIG. 3C illustrates an exemplary GUI 340 associated with event detection system 116 and application 110, according to example embodiments. In some embodiments, GUI 340 may be generated by reporting module 126 based on information generated by production prediction module 124. GUI 340 may be sent to user device 102 for display via application 110.

As shown, GUI 340 may include a chart 342 that illustrates decline curve 304 and decline curve 324 fit to previously received production data and decline curve 344 fit to newly received production data. After another six years of production, the target well is shut for four months. Event detection system 116 may detect or identify this downtime and may generate a new production curve to reflect the updated production potential. As shown, the newly detected shut-in event, corresponding to decline curve 344, reduced the forecasted production profile of the target well, which can be visualized by comparing decline curve 344 to decline curve 304 and decline curve 324.

FIG. 3D illustrates an exemplary GUI 360 associated with event detection system 116 and application 110, according to example embodiments. In some embodiments, GUI 360 may be generated by reporting module 126 based on information generated by production prediction module 124. GUI 360 may be sent to user device 102 for display via application 110.

As shown, GUI 360 may include a chart 362 that illustrates decline curve 304, decline curve 324, and decline curve 344 fit to previously received production data and decline curve 364 fit to newly received production data. Chart 362 may reflect the target well be shut-in during late 2022 for offset infill activity. Event detection system 116 may quantify the positive production impact that this offset infill activity had on later-life well. For example, as shown, the newly detected shut-in event, corresponding to decline curve 364, improved the forecasted production profile of the target well relative to the shut-in events corresponding to decline curve 304 and 344.

FIG. 3D illustrates an exemplary GUI 400 associated with event detection system 116 and application 110, according to example embodiments. In some embodiments, GUI 400 may be generated by reporting module 126 based on information generated by production prediction module 124. GUI 400 may be sent to user device 102 for display via application 110.

As shown, GUI 400 may include a chart or table 402. Table 402 may include data associated with detected shut-in events for a target well. Table 402 may include several columns, which may include, but are not limited to API well number (unique number representing the well), event start date, event end date, shut-in event classification, forecasted estimated ultimate recovery for the first 360 months following the shut-in event, and the impact of the forecasted estimated ultimate recovery for the first 360 months following the shut-in event (i.e., the delta between two successive shut-in events). Table 402 may be representative of a historic record of all production events that have occurred for a specific well, with various additional detail about the impacts of those events.

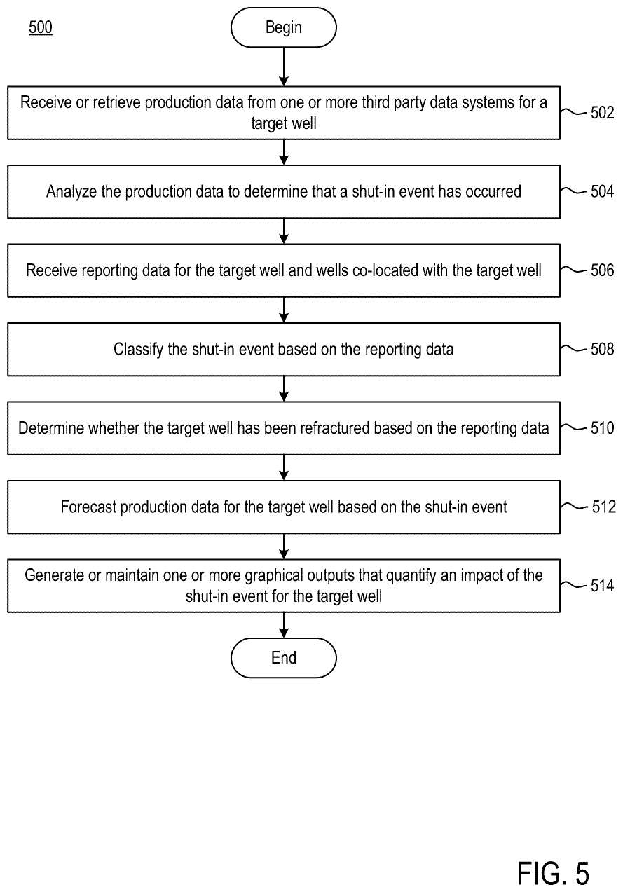

FIG. 5 is a flow diagram illustrating a method 500 for well event detection and prediction, according to example embodiments. Method 500 may begin at step 502.

At step 502, server system 104 may receive or retrieve production data from one or more third party data systems 106. Production data may represent production data that has been reported for a target well. In some embodiments, production data may include production data for both oil production and gas production for a target well. In some embodiments, production data may be received in real-time, near real-time, or periodically production data for a target well.

At step 504, server system 104 may analyze the production data to determine that a shut-in event has occurred. A shut-in event may broadly refer to an event during operation of a target well in which the operation is halted or suspended by closing the valves at the wellhead. In some embodiments, shut-in event detector 120 may detect a shut-in event based on the received production data for the target well. Shut-in event detector 120 may analyze the production data to determine whether a shut-in event has occurred based on previously defined definitions of what constitutes a shut-in event.

At step 506, server system 104 may receive reporting data for the target well and wells co-located with the target well from one or more third party data systems 106. For example, shut-in event classifier 122 may receive reporting data for the target well. In some embodiments, the reporting data may indicate whether a refracture event has occurred on the target well. In some embodiments, shut-in event classifier 122 may receive reporting data for wells co-located with the target well. For example, shut-in event classifier 122 may receive reporting data for wells on the same pad as the target well, using the pad identifier associated with the target well. In another example, shut-in event classifier 122 may receive reporting data for wells located on pads adjacent to the target well.

At step 508, server system 104 may classify the shut-in event based on the reporting data. Shut-in event classifier 122 may classify the shut-in event into one of a plurality of possible categories of shut-in events. Exemplary categories of shut-in events may include, but are not limited to pad infill events, offset infill events, and shut-in events. Pad infill event may broadly refer to an event (e.g., spud or rig release date) that occurs on the same well pad as the target well.

Offset infill events may broadly refer to an event (e.g., spud or rig releasee date) that occurs on a well pad adjacent to the target well pad of the target well. Whether a well pad is adjacent to a target pad may depend on whether a determined distance between the well pad and the target well pad is below a threshold amount. In some embodiments, the distance may be determined based on an average distance of wells in the target pad to wells in the other pad. Shut-in events may broadly refer to all other events that do quality as either a pad infill event, offset infill event, or refraction event.

Shut-in event classifier 122 may classify the detected shut-in event based on reported information retrieved from third party data systems 106. For example, shut-in event classifier 122 may classify a shut-in event as a pad infill event based on the pad identifiers associated with the wells in the reported information. Shut-in event classifier 122 may similarly classify a shut-in event as an offset infill event based on wells associated with pad identifiers of pads determined to be adjacent to the target pad of the target well.

In some embodiments, shut-in event classifier may not yet have the necessary information for classifying the shut-in event. For example, reporting records for the same well, same pad, or adjacent wells may not yet be reported or available from third party data system(s) 106. For example, as shown, reporting data 203 and reporting data 205 may be reported or retrieved by shut-in event classifier 122 periodically, as they are made available or posted by third party data systems 106. Shut-in event classifier 122 may initially classify the shut-in event as a generic shut-in event, with the expectation that later received production data will help provide clarification for the type of shut-in event.

At step 510, server system 104 may determine whether the target well has been refractured. For example, shut-in event classifier 122 may analyze reporting data 203 to determine if a refracture event has been reported for the target well. Similar the process discussed above in conjunction with step 508, shut-in event classifier 122 may not have the necessary information to determine whether a refracture event has occurred. As such, shut-in event classifier 122 may continuously or periodically analyze streams of reporting data to determine if a refracture event has occurred.

At step 512, server system 104 may forecast production data for the target well based on the shut-in event. In some embodiments, production module 124 may forecast production data for the target well for the segment of the production data corresponding to the detected shut-in event. In some embodiments, production prediction module 124 may forecast production data for the segment of production data for the target well by applying a decline curve analysis to the production data. In this manner, production prediction module 124 may project the effect of the shut-in event on the production of the target well.

At step 514, server system 104 may generate or maintain one or more graphical outputs that quantify an impact of the shut-in event for the target well. In some embodiments, one or more graphical outputs may include a table of metrics for the target well. For example, the table may include various metrics associated with detected shut-in events, such as, but not limited to the date of the shut-in event, the duration of the shut-in event, estimated ultimate recovery projection of the shut-in event, or the like. Such table may be stored in data store 150 for subsequent updating.

In some embodiments, reporting module 126 may generate one or more graphical outputs quantifying the impact of the detected shut-in events.

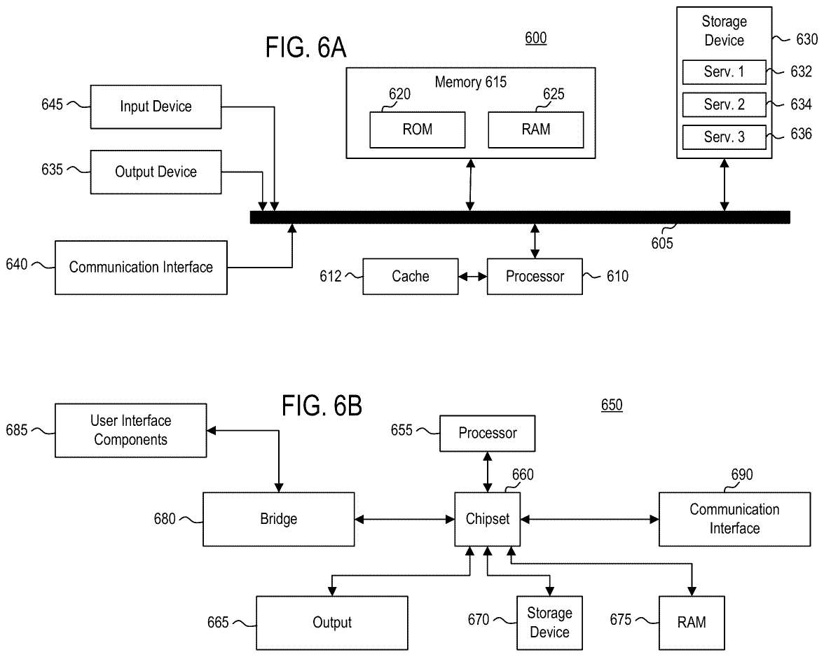

FIG. 6A illustrates a system bus architecture of computing system 600, according to example embodiments. System 600 may be representative of at least user device 102 or server system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random-access memory (RAM) 625, to processor 610.

System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general-purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635 (e.g., display), and so forth, to carry out the function.

FIG. 6B illustrates a computer system 650 having a chipset architecture that may represent user device 102 or server system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655.

In this example, chipset 660 outputs information to output 665, such as a display, and may read and write information to storage device 670, which may include magnetic media, and solid-state media, for example. Chipset 660 may also read data from and write data to storage device 675 (e.g., RAM). A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or storage device 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method for well event detection and production prediction, the method comprising:
identifying, by a computing system, production data for a target well from one or more third party data systems, the production data comprising oil or gas production for the target well;
detecting, by the computing system, a shut-in event by analyzing the production data for the target well, the shut-in event corresponding to an event during operation of the target well in which operation of the target well is halted or suspended;
receiving, by the computing system, reporting data for the target well and a plurality of wells co-located with the target well;
classifying, by the computing system, the detected shut-in event into one of a plurality of possible categories of shut-in events based on the reporting data, the plurality of possible categories of shut-in events comprising a pad shut-in event, an offset shut-in event, or a generic shut-in event;
determining, by the computing system, whether a refracture event has occurred for the target well based on the reporting data;
forecasting, by the computing system, an impact of the shut-in event on future production of the target well using decline curve analysis on a segment of the production data corresponding to the shut-in event; and
causing, by the computing system, display of one or more graphical elements quantifying the impact of the shut-in event for the target well.

2. The method of claim 1, wherein detecting, by the computing system, the shut-in event by analyzing the production data for the target well comprises:
determining that the target well is in its early stages as defined by a period between initial production peak and two months post peak; and
detecting a month over month decline of a threshold percentage for consecutive months.

3. The method of claim 2, further comprising:
detecting a threshold minimum peak value in production.

4. The method of claim 1, wherein detecting, by the computing system, the shut-in event by analyzing the production data for the target well comprises:
detecting a month over month decline of a threshold percentage for consecutive months.

5. The method of claim 1, wherein classifying, by the computing system, the detected shut-in event into one of the plurality of possible categories of shut-in events based on the reporting data comprises:
identifying a pad associated with the target well;
determining that a pad underwent an infill well event; and
based on the determining, classifying the shut-in event as a pad shut-in event.

6. The method of claim 1, wherein classifying, by the computing system, the detected shut-in event into one of the plurality of possible categories of shut-in events based on the reporting data comprises:
identifying a pad associated with the target well;
identifying a plurality of other pads adjacent to the pad associated with the target well;
determining that one of the plurality of other pads underwent an infill well event; and
based on the determining, classifying the shut-in event as an offset shut-in event.

7. The method of claim 1, wherein classifying, by the computing system, the detected shut-in event into one of the plurality of possible categories of shut-in events based on the reporting data comprises:
determining that the reporting data does not include reporting information associated with a pad associated with the target well or other pads adjacent to the target well; and
based on the determining, classifying the shut-in event as a generic shut-in event.

8. A non-transitory computer readable medium comprising one or more sequences of instructions, which, when executed by a processor, causes a computing system to perform operations comprising:
identifying, by the computing system, production data for a target well from one or more third party data systems, the production data comprising oil or gas production for the target well;
detecting, by the computing system, a shut-in event by analyzing the production data for the target well, the shut-in event corresponding to an event during operation of the target well in which operation of the target well is halted or suspended;
receiving, by the computing system, reporting data for the target well and a plurality of wells co-located with the target well;
classifying, by the computing system, the detected shut-in event into one of a plurality of possible categories of shut-in events based on the reporting data, the plurality of possible categories of shut-in events comprising a pad shut-in event, an offset shut-in event, or a generic shut-in event;
determining, by the computing system, whether a refracture event has occurred for the target well based on the reporting data;
forecasting, by the computing system, an impact of the shut-in event on future production of the target well using decline curve analysis on a segment of the production data corresponding to the shut-in event; and
causing, by the computing system, display of one or more graphical elements quantifying the impact of the shut-in event for the target well.

9. The non-transitory computer readable medium of claim 8, wherein detecting, by the computing system, the shut-in event by analyzing the production data for the target well comprises:
determining that the target well is in its early stages as defined by a period between initial production peak and two months post peak; and
detecting a month over month decline of a threshold percentage for consecutive months.

10. The non-transitory computer readable medium of claim 9, further comprising:
detecting a threshold minimum peak value in production.

11. The non-transitory computer readable medium of claim 8, wherein detecting, by the computing system, the shut-in event by analyzing the production data for the target well comprises:
detecting a month over month decline of a threshold percentage for consecutive months.

12. The non-transitory computer readable medium of claim 8, wherein classifying, by the computing system, the detected shut-in event into one of the plurality of possible categories of shut-in events based on the reporting data comprises:
identifying a pad associated with the target well;
determining that a pad underwent an infill well event; and
based on the determining, classifying the shut-in event as a pad shut-in event.

13. The non-transitory computer readable medium of claim 8, wherein classifying, by the computing system, the detected shut-in event into one of the plurality of possible categories of shut-in events based on the reporting data comprises:
identifying a pad associated with the target well;
identifying a plurality of other pads adjacent to the pad associated with the target well;
determining that one of the plurality of other pads underwent an infill well event; and
based on the determining, classifying the shut-in event as an offset shut-in event.

14. The non-transitory computer readable medium of claim 8, wherein classifying, by the computing system, the detected shut-in event into one of the plurality of possible categories of shut-in events based on the reporting data comprises:
determining that the reporting data does not include reporting information associated with a pad associated with the target well or other pads adjacent to the target well; and
based on the determining, classifying the shut-in event as a generic shut-in event.

15. A system comprising:
a processor; and
a memory having programming instructions stored thereon, which, when executed by the processor, causes the system to perform operations comprising:
identifying production data for a target well from one or more third party data systems, the production data comprising oil or gas production for the target well;
detecting a shut-in event by analyzing the production data for the target well, the shut-in event corresponding to an event during operation of the target well in which operation of the target well is halted or suspended;
receiving reporting data for the target well and a plurality of wells co-located with the target well;
classifying the detected shut-in event into one of a plurality of possible categories of shut-in events based on the reporting data, the plurality of possible categories of shut-in events comprising a pad shut-in event, an offset shut-in event, or a generic shut-in event;
determining whether a refracture event has occurred for the target well based on the reporting data;
forecasting an impact of the shut-in event on future production of the target well using decline curve analysis on a segment of the production data corresponding to the shut-in event; and
causing display of one or more graphical elements quantifying the impact of the shut-in event for the target well.

16. The system of claim 15, wherein detecting the shut-in event by analyzing the production data for the target well comprises:
determining that the target well is in its early stages as defined by a period between initial production peak and two months post peak; and
detecting a month over month decline of a threshold percentage for consecutive months.

17. The system of claim 15, wherein detecting the shut-in event by analyzing the production data for the target well comprises:
detecting a month over month decline of a threshold percentage for consecutive months.

18. The system of claim 15, wherein classifying the detected shut-in event into one of the plurality of possible categories of shut-in events based on the reporting data comprises:
identifying a pad associated with the target well;
determining that a pad underwent an infill well event; and
based on the determining, classifying the shut-in event as a pad shut-in event.

19. The system of claim 15, wherein classifying the detected shut-in event into one of the plurality of possible categories of shut-in events based on the reporting data comprises:
identifying a pad associated with the target well;
identifying a plurality of other pads adjacent to the pad associated with the target well;
determining that one of the plurality of other pads underwent an infill well event; and
based on the determining, classifying the shut-in event as an offset shut-in event.

20. The system of claim 15, wherein classifying the detected shut-in event into one of the plurality of possible categories of shut-in events based on the reporting data comprises:
determining that the reporting data does not include reporting information associated with a pad associated with the target well or other pads adjacent to the target well; and
based on the determining, classifying the shut-in event as a generic shut-in event.
